(19) United States
(12) Patent Application Publication
(10) Pub. No.: US 2008/0201956 A1
(43) Pub. Date: Aug. 28, 2008

(54) Hot dog cutting device

(76) Inventors: Todd R. Bouton, Janesville, WI (US); Angela K. Bouton, Janesville, WI (US)

Correspondence Address: TODD RICHARD BOUTON, 3742 BREAMORE DR, JANESVILLE, WI, 53548, US

(21) Appl. No.: 11/709,356

(22) Filed: Feb. 22, 2007

(51) Int. Cl. B26B 3/04

(52) U.S. Cl. 30/114

(57) ABSTRACT

Molded in at least five discrete parts. Each of which are adapted to engage together to safely long wedge cut, slice, and then 3d dice a sausage food product. In this device one handle acts as a guide with no cutting means for a sausage while it's inserted in a cutter housing.

The cutter housing and two handle beam apparatus could be pushed down at this point to reveal individual through slices down the sausage length.

The opposite end of a two handle beam apparatus would have a cutting means for a sausage, than inserted into a cutter housing. At this point the respective cutter housing and respective two handle beam apparatus could be lifted off a food ejector to reveal long end to end wedge cuts.

Both, the long end cut operation, and sliced cut operation together would create a diced sausage product.

### FIELD AND BACKGROUND OF THE INVENTION

The present invention relates in general to a kitchen cutting device and in particular to a new and useful manual safer cutting device with a quick and easy way to slice, dice, and create long wedge cuts through an elongated hotdog and or a sausage food product known in the art as frankfurters or wieners. Prior art shows that inventions that cut a plurality of slices down the longitudinal length, by way of example, U.S. Pat. No. 5,499,578 and U.S. Pat. No. 5,456,010 require the handling and use of a knife to execute a cut.

When my invention cuts a plurality of slices down the longitudinal length of a sausage, it is equipped with an array of cutting blades completely enclosed inside of a housing to avoid any kind of accidental cuts caused by the now unnecessary use of an exposed knife.

Prior art shows that inventions that cut long longitudinal wedge pieces, by way of example, U.S. Pat. No. 2,675,580 requires that a person have one hand on the sausage while simultaneously forcing the sausage through the cutter knives leaving the possibility of personal injury to there figures from this form of usage.

My invention puts to use a two handle beam apparatus, and a hotdog barrier to to execute a cut, while a person having one hand on the tubular containment chamber, forces the tubular containment cutting chamber past the respective hotdog barrier while simultaneously cutting long longitudinal wedge pieces of a sausage from one end to the other.

Prior art also shows that inventions that create long longitudinal wedge cuts in the security of a cutting chamber by way of example, U.S. Pat. No. 5,771,771 do not allow long longitudinal cuts to sever all the way through with in the cutting chamber, leaving a diameter of at least one-quarter of an inch of longitudinal core down the center of the sausage.

Other prior art also shows that inventions that create diced cuts in the security of a cutting chamber by way of example, U.S. Pat. No. 7,065,880 does not show any obvious locking mechanism to prevent the execution of the cutting blades while the chamber is open.

In my invention, a person would have a choice of sliced, diced, or long longitudinal wedge severed through completely discrete pieces of sausage, and would ultimately offer kids, elderly, and people of all ages a better way to prevent choking or any kind of blocking of the air way, from a large sausage, or loosely connected pieces of hotdogs in an totally safe manner.

While these devices fulfill their respective, particular objectives and requirements for cutting a sausage food product. The aforementioned patents do not describe a sausage cutter for creating cubed or diced cut through pieces in a safe manner. Therefore the above mentioned patents do not fulfill the true objective of a totally safe means for cutting.

In both respects, the sausage cutter according to the present invention substantially departs from the conventional concepts and designs of the prior art, and in doing so provides an apparatus primarily developed for the purpose of finding a safer method for slicing, dicing, and creating long wedge cuts of a sausage food product as I have done in my mockup.

### BRIEF SUMMARY AND OBJECT OF THE INVENTION

The invention seeks to realize among other things the following:

The object of the invention is to provide a novel cutting mechanism that combines long cut capabilities with short sliced cut capabilities to create diced or cubed sausage and simply cutting a hotdog with less time and work.

A principle object of the present invention is to have several designs and sizes to accommodate several size sausages, and could even be used to slice and dice a large variety of different food products, like soft fruits and vegetables as well. A further important object of the present invention is to provide a safe easy way for elder people to cut there own sausage product the way they like them cut for ease of eating.

Another major object of the invention is to provide a fast and safe way for the on the go mom and dad to slice or dice the hot dogs in small easy to swallow pieces for the younger kids.

Another principle object is to provide a quick and safe three step operation for slicing and dicing a sausage product with out using a much slower and more dangerous knife.

Yet another principle object is to provide a mechanism with a momentary containment chamber that holds the sometimes hot finished cut up sausage product until it's ready to be served on a plate.

Yet another object of the present invention is to provide a cutting device that's possibly made of plastic and easily unassembled for washing by hand in a kitchen sink, or in a dish washer.

Still another object of the present invention is to provide a device that will make foods prepared with sliced and diced up sausages less cumbersome and fun for everyone of all ages in the family to prepare.

It is a further object of the invention to provide a lever locking device that can only be released by either end of the two handle beam apparatus midway through the plunge cutter housing, to ensure the device can only be used safely and properly.

These and other objects and advantages of the invention will become more fully apparent from the description of the views and the detailed embodiments that follow, or may be learned by the practice of the invention.

### BRIEF DESCRIPTION OF THE DRAWINGS

FIG. 1: Is a front, top, left side isometric view of a two handle beam apparatus protruding out both sides of a cutter housing just above a food ejector. This view also shows the three different cuts made on a hot dog from this device.

FIG. 2: Is a front, top, left side isometric view of a two handle beam apparatus showing a large sausage food product up above, and a small sausage food product down below.

FIG. 3: Is a front, top, left side isometric view of a two handle beam apparatus with a tubular sleeve containment cutting chamber at on end showing a large sausage food product up above, and a small sausage food product down below.

FIG. 4: Is a front, top, left side isometric view of a two handle beam apparatus with a tubular sleeve containment cutting chamber at on end showing a small sausage food product down below.

FIG. 5: Is a front, top, left side isometric view of a food ejector showing a large sausage food product up above.

FIG. 6: Is a front, top and left side isometric view of a cutter housing showing a large sausage food product up above.

FIG. 7: Is a front, bottom, left side isometric view of a cutter housing showing a large sausage food product up above.

FIG. 8: Is a front, top, left side isometric view of a two handle beam apparatus having a cutter housing at one end and a tubular sleeve containment cutting chamber at the opposite end. A food barrier is also shown mounted in the respective cutter housing.

FIG. 9: Is a front, top, right side isometric view showing a tubular sleeve containment cutting chamber in front of a two handle beam apparatus having a food barrier at one end unassembled from a cutter housing (the respective cutter housing not shown in this view).

FIG. 10: Is a front, bottom, left side isometric view of a cutter housing above a front, top, left side isometric view of a food ejector.

FIG. 11: Is a front, bottom, left side isometric view of a cutter housing showing one lower lever lock unassembled and an upper lever lock assembled, (all three sharing the same view).

FIG. 12: Is a front, top, right side isometric view of a cutter housing mounted over top of a food ejector forming a momentary food containment chamber together and showing the lever locks holding it up.

A sausage food product and a two handle beam apparatus also sharing the same view are both in line with a food product inlet, located at one end of the respective cutter housing.

FIG. 13: Is a front, bottom, left side isometric view of a large sausage food product inside of a tubular containment chamber located at one end of a two handle beam apparatus.

FIG. 14: Is a front, top, right side isometric view of a two handle beam apparatus protruding out both sides of a cutter housing mounted over top of a food ejector forming a momentary food containment chamber together, with a large sausage food product shown in dark hidden lines. This view also shows the lever locks rotated away from there lock stop ledges located on the respective food ejector.

FIG. 15: Is a front, top, left side isometric view of a large sausage food product inside of a tubular containment cutting chamber located at one end of a two handle beam apparatus, having a tubular sleeve containment cutting chamber shown at the opposite end.

FIG. 16: Is a front, top, right side isometric view of a two handle beam apparatus protruding out both sides of a cutter housing mounted over top of a food ejector forming a momentary food containment chamber together, with a large sausage food product shown in dark hidden lines. This view also shows the lever locks rotated away from there lock stop ledges located on the respective food ejector.

FIG. 17: Is a front, top, left side isometric view of a two handle beam apparatus protruding out both sides of a cutter housing just above a food ejector. This view also shows the long wedge cuts made on a hot dog created from this device.

FIG. 18: Is a front, top, left side isometric view of a large sausage food product inside of a tubular sleeve containment cutting chamber shown at one end of a two handle beam apparatus.

FIG. 19: Is a front, top, right side isometric view of a two handle beam apparatus protruding out both sides of a cutter housing mounted over top of a food ejector forming a momentary food containment chamber together, with a large sausage food product shown in dark hidden lines. This view also shows a (drawn cut out viewing window), through a tubular containment cutting chamber to show a tubular sleeve containment cutting chamber telescopically mounted.

FIG. 20: Is a front, top, left side isometric view of a two handle beam apparatus protruding out both sides of a cutter housing pushed all the way down over top of a food ejector.

### DETAILED DESCRIPTION OF THE EMBODIMENT

Part number one: A two handle beam apparatus.

In the drawings, reference numeral 2 istermed and generally indicates a two handle beam apparatus in accordance with the invention.

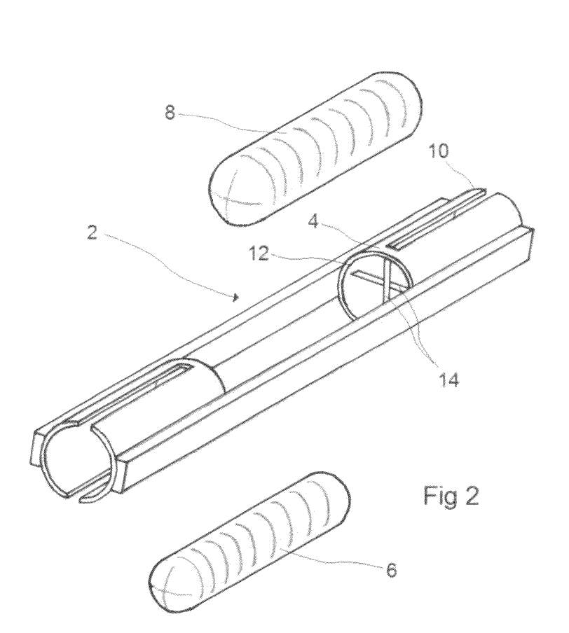

FIG. 2 A two handle beam apparatus 2 for slicing a sausage food product includes at one end a tubular containment cutting chamber 4 having a longitudinal length generally similar to a standard size sausage product, 6 and an inside diameter with a generally larger circumference than a jumbo size sausage product 8 outside circumference.

A tubular containment cutting chamber 4 having a food product inlet 10 at one end and a food product outlet 12 which is provided with a knife or wire 14 for cutting.

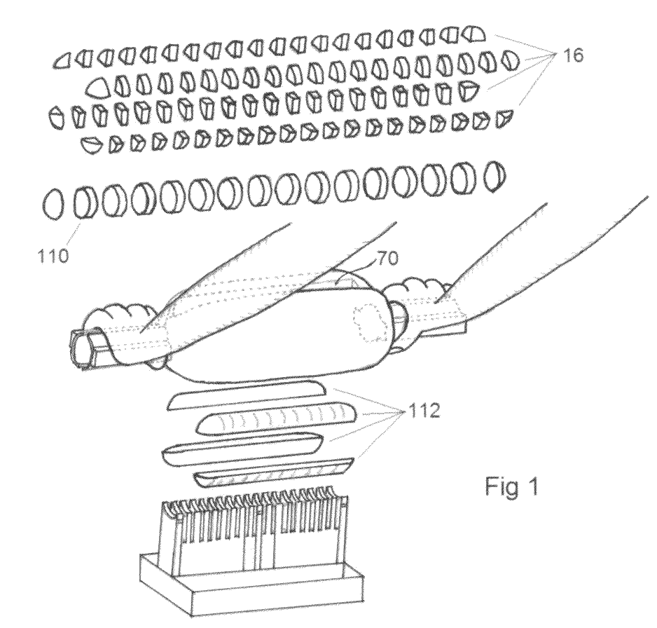

FIG. 1 At this point the ultimate focus is on a diced sausage food product, 16 so it would require, but not limited too, FIG. 2 more than one knife or wire 14 used for cutting a jumbo size sausage product 8, and the respective knifes or wires 14 would be spaced at a ninety degree angle from each other around the inside circumference of a tubular containment cutting chamber 4 food product outlet end 12.

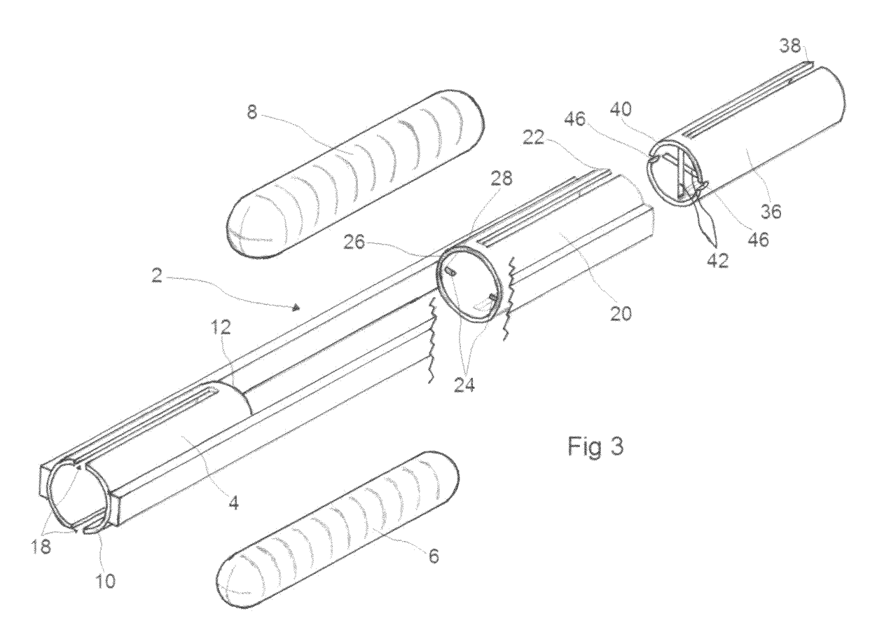

FIG. 3 An elongated stop slot 18 shown cut through from the outer surface to the inner surface of a tubular containment cutting chamber 4 having the same longitudinal axis.

A stop slot 18 having an opening from the food product inlet end 10, and extending the respective opening to a distance just short of the food product outlet end 12 without an opening.

A two handle beam apparatus 2 for slicing a sausage food product includes at the opposite longitudinal end a tubular containment chamber 20 having a longitudinal length generally similar to a standard size sausage product 6, and an inside diameter with a generally larger circumference than a jumbo size sausage products 8 outside circumference.

A tubular containment chamber 20 is provided with a food product inlet 22 at one end and a food product outlet 26 at the other end, with two short sleeve locator pins 24 located across from each other generally near the respective food product outlet end 26.

A sleeve locator pin 24 having a fixed mount 28 (only one of two fixed mounts shown n FIG. 3) in a transverse position from a tubular containment chambers 20 inside surface pointing inwardly.

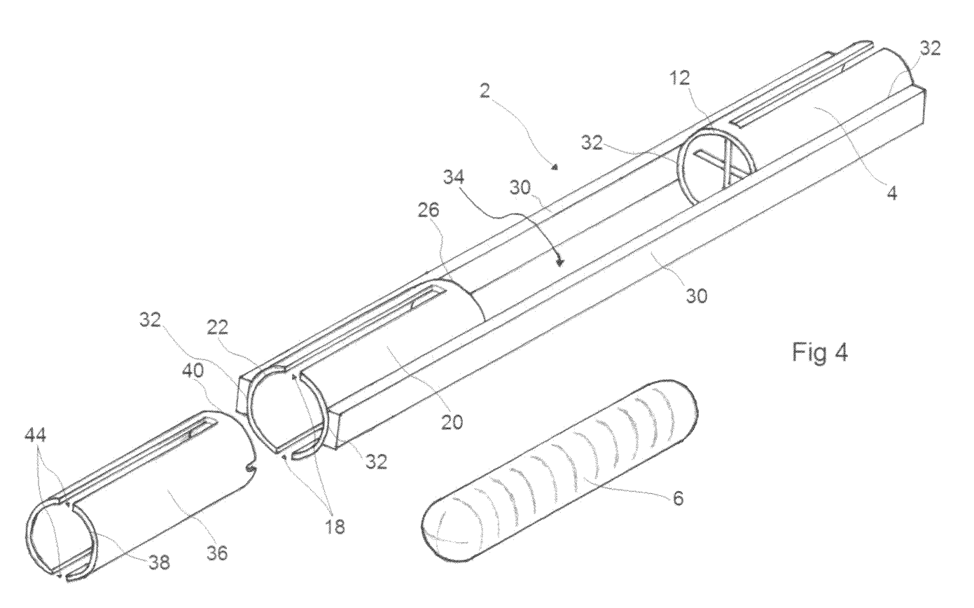

FIG. 4 An elongated stop slot 18 shown cut through from the outer surface to the inner surface of a tubular containment chamber 20 having the same longitudinal axis.

A stop slot 18 having an opening from the food product inlet end 22 and extending the respective opening to a distance just short of the food product outlet end 26 without an opening.

A horizontal guide beam 30 having the same longitudinal axis as a tubular containment cutting chamber 4 and a tubular containment chamber 20.

A tubular containment cutting chamber 4 and the tubular containment chamber 20 have a fixed mount 32 on the outer surface with a guide beam 30.

A middle portion 34 of a guide beam 30 spanning an opening between the food product outlet end 12 of a tubular containment cutting chamber 4 and the food product outlet end 26 of a tubular containment chamber 20 generally longer than the distance of a standard size sausage product 6, forming a two handle beam apparatus 2 all together.

Part number two: A tubular sleeve containment cutting chamber.

FIG. 3 A tubular sleeve containment cutting chamber 36 is in the form of a generally smaller version of a tubular containment cutting chamber 4, to except a telescopic sleeve mount from a tubular containment chamber 20.

A tubular sleeve containment cutting chamber 36 having a longitudinal length generally similar to a standard size sausage product 6, and an inside diameter with a generally larger circumference than the respective standard size sausage products 6 outside circumference.

A tubular sleeve containment cutting chamber 36 having an outside diameter generally smaller than a tubular containment chambers 20 inside diameter.

A tubular sleeve containment cutting chamber 36 having a food product inlet 38 at one end, and a food product outlet 40 which is provided with a knife or wire 42 for cutting.

FIG. 1 At this point the ultimate focus is on a diced sausage food product 16, so it would require, but not limited too, FIG. 3 more than one knife or wire 42 used for cutting a standard size sausage product 6, and the respective knifes or wires 42 would be spaced at a ninety degree angle from each other around the inside circumference of a tubular sleeve containment cutting chambers 36 food product outlet end 40.

FIG. 4 An elongated stop slot 44 shown cut through from the outer surface to the inner surface of a tubular sleeve containment cutting chamber 36 having the same longitudinal axis.

A stop slot 44 having an opening from the food product inlet end 38 and extending the respective opening to a distance just short of the food product outlet end 40 without an opening.

A tubular sleeve containment cutting chambers 36 food outlet end 40 is telescopically forced by hand into a tubular containment chambers 20 food inlet end 22.

FIG. 3 A tubular sleeve containment cutting chamber 36 having a generally short sleeve locator slot 46 with an opening at its food product outlet end 40.

A sleeve locator slot 46 is used for locating, aligning, and stopping a telescopically mounted tubular sleeve containment cutting chamber 36 with a generally short sleeve locator pin 24 inside a tubular containment chamber 20.

Part number three: A food ejector.

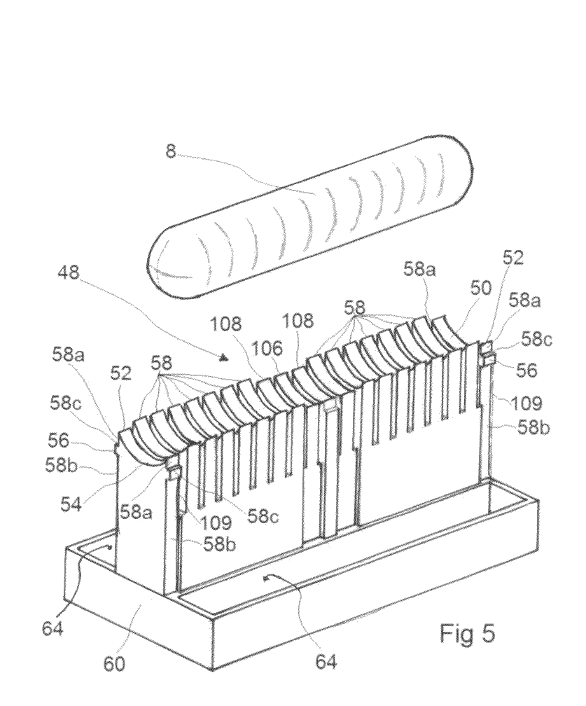

FIG. 5 In the drawings, reference numeral 48 istermed and generally indicates a food ejector in accordance with the invention.

A plurality of pusher blades 58, 106, 108, 109 extending generally up a food ejector 48.

A food ejector 48 is provided with a top surface 50 longitudinally configured generally longer and generally wider than a jumbo size, sausage product 8 having the respective top surface 50 recessed, with sides 52 higher than the center 54, creating a lateral centering means for the respective jumbo size sausage product 8. A food ejector 48 having an array of transversely oriented clearance slots open from the top surface 50 and opened on both side surfaces 56 extending downwardly to a predetermined clearance depth forming pusher blades 58, 106, 108, 109.

An upper depression 58a located on a pusher blades 109 side surface 56 at each end of a food ejector 48, in the form of an upper relief.

A lower depression 58b (only three of four lower depressions shown in FIG. 5) located on a pusher blades 109 side surface 56 at each end of a food ejector 48, in the form of a lower relief.

A side surface 56 that stands between an upper depression 58a and a lower depression 58b located on a pusher blade 109, takes the form of a momentary locator ledge 58c (only three of four momentary locator ledges shown in FIG. 5). A top surface of a base 60 is fixed mounted to the bottom of a food ejector 48 having generally the same longitudinal length, and extending out laterally for enhanced stability in the form of a reservoir 64 on each side.

Part number four: A cutter housing.

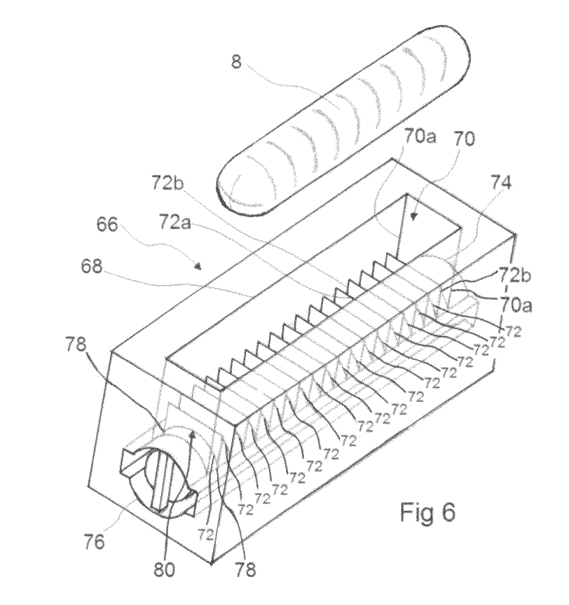

FIG. 6 In the drawings, reference numeral 66 istermed and generally indicates a cutter housing in accordance with the invention.

A cutter housing 66 is provided with a food product outlet 68 on the top surface longitudinally configured to be generally longer, and generally wider than one jumbo size sausage product 8.

A cutter housing 66 is provided with an upper momentary food containment chamber 70 from the top surface to be generally deeper than the thickness of a jumbo size sausage product 8.

An upper momentary food containment chamber 70 is provided with an array of transversely oriented cutting blades 72 configured longitudinally.

A cutter blades 72 top surface 72a starts from the bottom of the respective upper momentary food containment chamber 70, and extends downwardly to a sharp edge similar to a knife, taking the form of the top circumference on a handle beam inlet 74, and handle beam outlet 76.

A cutter blades 72 lateral ends have a fixed mount 72b to an upper momentary food containment-chambers 70 inside surfaces 70a.

A bottom sharp edge of a cutter blade 72 having the sides 78 lower than the center 80 of the respective cutter blade 72, longitudinally configured into a lateral centering and cutting means for a jumbo size sausage product 8.

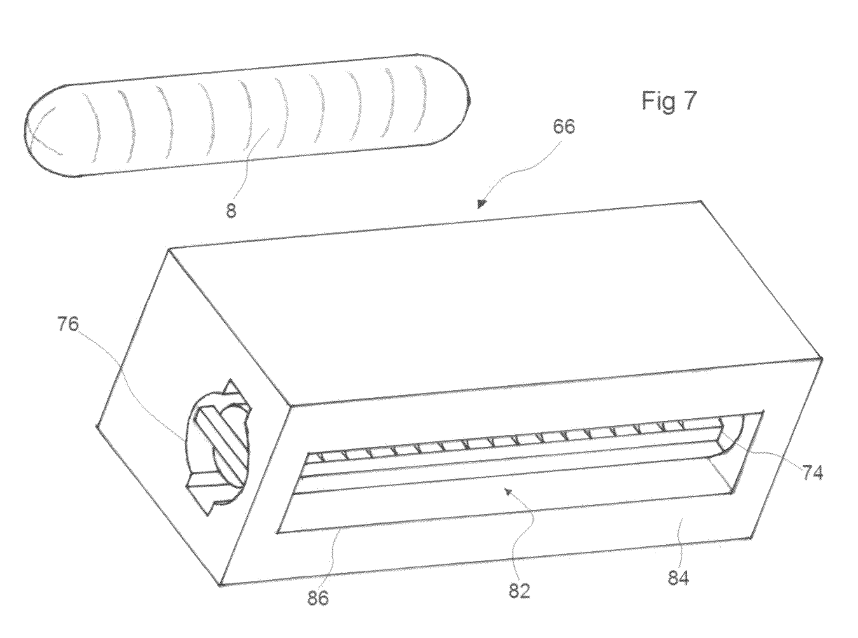

FIG. 7 A cutter housing 66 is provided with a handle beam inlet 74 at one end, and a handle beam outlet 76 at the opposite longitudinal end having the middle portion forming a lower momentary food containment chamber 82 opened therethrough to the bottom surface 84 of the respective cutter housings 66 food ejector inlet 86.

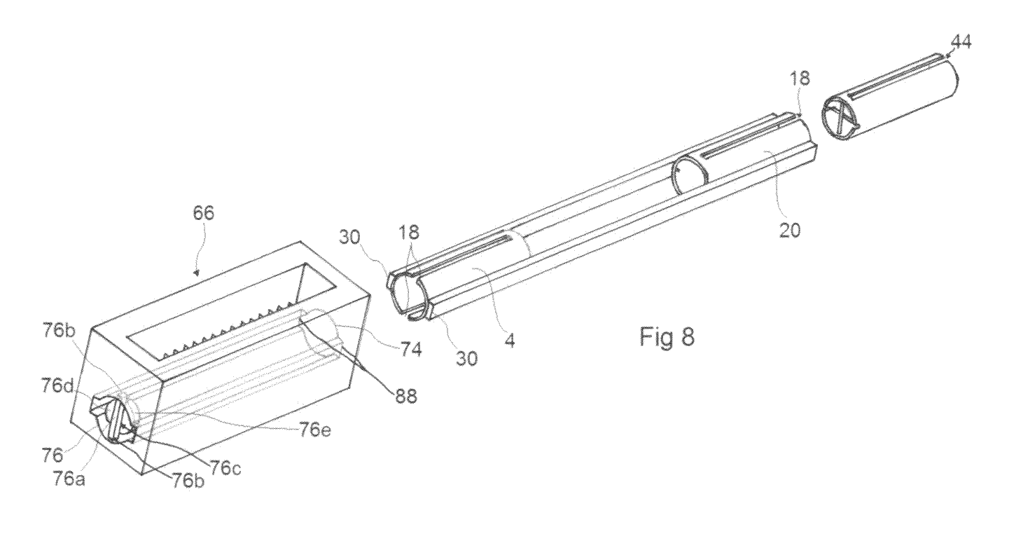

FIG. 8 A handle beam inlet 74 and a handle beam outlet 76 having a generally slightly larger inside circumference than a tubular containment cutting chamber 4 and a tubular containment chambers 20 out side circumference.

A handle beam inlet 74 and a handle beam outlet 76 are provided with openings on there inside circumference called a guide beam slot 88 oriented longitudinally all the way through a cutter housing 66.

A guide beam slot 88 having a generally slightly larger inside dimension than a guide beams 30 outside dimension.

A handle beam outlet 76 located on one end of a cutter housing 66 is provided with a center mounted vertically oriented pillar 76a having a top and bottom fixed mount 76b to the inside circumference of the respective handle beam outlet 76.

A pillar 76a having a generally smaller lateral thickness than a stop slot 18, 44 (only four of six stop slots shown in FIG. 8) lateral width opening.

A pillar 76a having a fixed mount 76c on a backside surface 76d of a food barrier 76e.

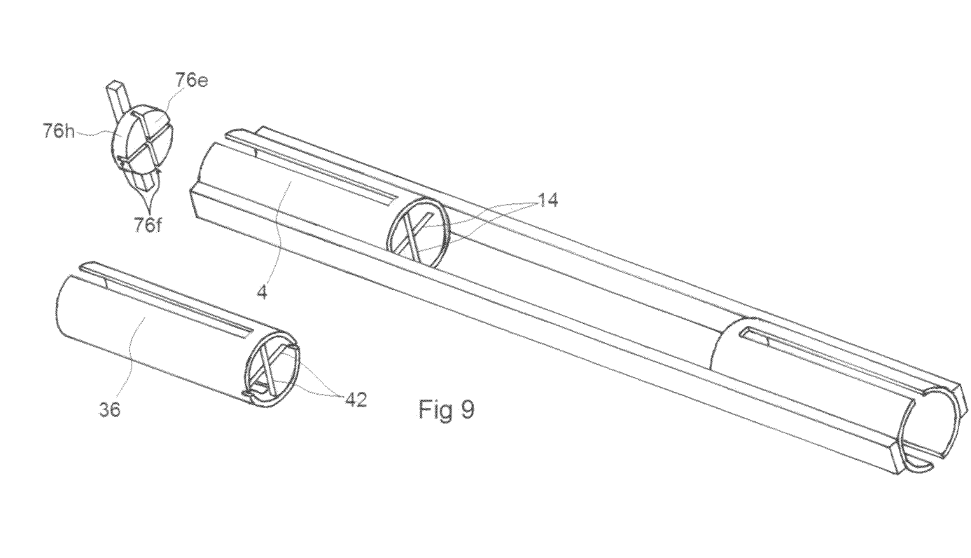

FIG. 9 A clearance slot 76f having a generally larger opening and depth than a knife or wire 14, 42 that's provided inside a tubular containment cutting chamber 4, and a tubular sleeve containment cutting chamber 36.

FIG. 1 At this point the ultimate focus is on a diced sausage product 16, so it would require, but not limited too, FIG. 9 more than one clearance slot 76f that would be spaced at a ninety degree angle from each other around the outside circumference 76h of a food barrier 76e.

FIG. 7 A cutter housing 66 is provided with a food ejector inlet 86 on it's bottom surface 84 longitudinally configured to be generally longer, and generally wider than one jumbo size sausage product 8.

A cutter housing 66 is provided with a lower momentary food containment chamber 82 having an opening on a bottom surface 84, which is termed a food ejector inlet 86, extending upwards to be a generally deeper pocket than two jumbo size sausage product 8.

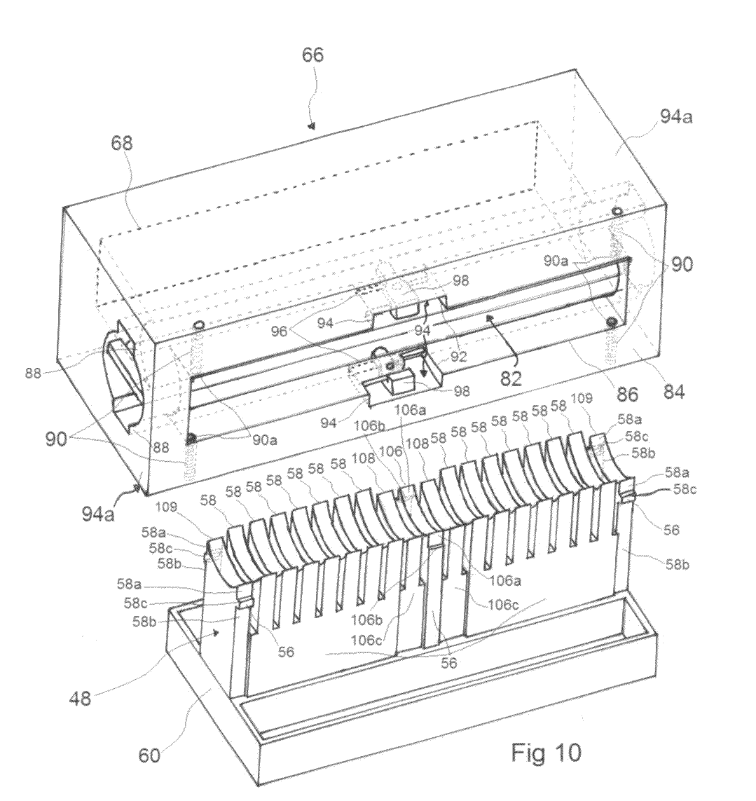

FIG. 10 A food ejector inlet 86 and a food product outlet 68 (68 shown in hidden lines in FIG. 10) located on a cutter housing 66, are provided with a slightly larger inside length and width dimension than a food ejector 48 and all of the pusher blades 58, 106, 108, 109 outside length and width dimension for an easy slip fit when the respective food ejector 48 and the respective cutter housing 66 are telescopically put together.

A cutter housing 66 provided with a spring plunger 90 in the form of a momentary locator point.

A spring plunger 90 having a transversely oriented fixed mount 90a on an inside surface 92 with all four momentary locator points, just inside a food ejector inlet 86, to line up with an upper depression 58a and a lower depression 58b located on a pusher blade 109 side surface 56.

A spring plunger 90 generally extending into a lower momentary food containment chamber 82 from a food ejector inlet 86 inside surface 92 to rest on a momentary locator ledge 58c, located on a side surface 56 of a pusher blade 109.

A cutter housing 66 is provide with a lever lock pocket 94 cut through from a bottom surface 84 to form a lever slot 96 opening to the lower portion of a guide beam slot 88 (both 96 and 88 shown in hidden lines in FIG. 10).

A cutter housing 66 is provide with a lever lock pocket 94 having openings on a bottom surface 84 generally part way up on an inside surface 92, and having no openings to an outside surface 94a.

Part number five: A lever lock.

In the drawings, reference numeral 98 istermed and generally indicates a lever lock in accordance with the invention.

A cutter housing 66 is provided with a lever lock 98 having the form of a class one lever.

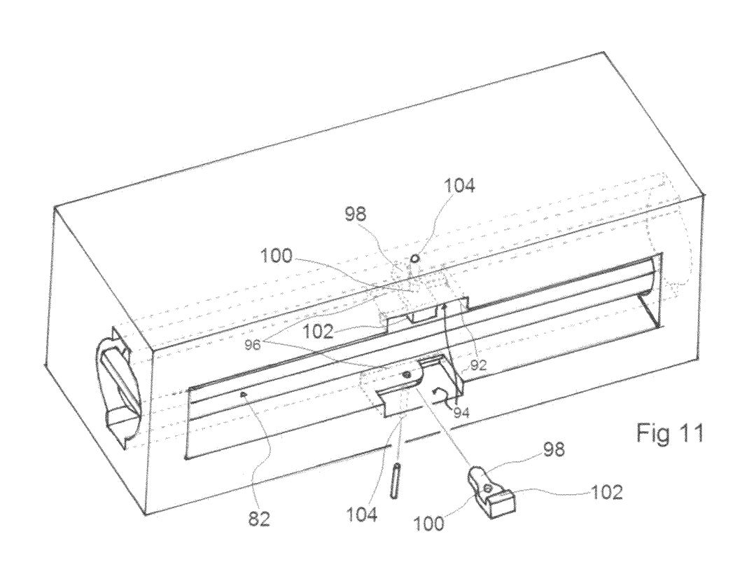

FIG. 11 A lever lock 98 is provided with a pivot hole 100 in the center acting as a fulcrum point on a class one lever.

A lever locks 98 lower ledge 102 portion is in the form of a boot, with the toe of the boot pointing inwardly generally beyond the inside surface 92 and protruding into a lower momentary food containment chamber 82. The respective lower ledge 102 of the respective lever lock 98 is used as a safety stop for a cutter housing 66, FIG. 10 when positioned on top of a center pusher blades 106 lock stop ledge 106b, located on a food ejector 48.

FIG. 11 A lower lever lock pocket 94 and upper lever slot 96 surface length openings (lever slot 96 shown in hidden lines in FIG. 11) are generally longer than a lever locks 98 total longitudinal length, allowing the respective lever lock 98 to rotate from a generally vertical position to a generally ninety degree horizontal position.

A lateral width of an upper lever slot 96 having a slightly larger slip fit for a lever locks 98 upper lateral width.

FIG. 10 A short upper depression 106a extending generally a short distance downwardly from a top surface on a center pusher blade 106, having the top edge of a remaining side surface 56 creating a lock stop ledge 106b (one lock stop ledge 106b shown in hidden lines in FIG. 10).

A long depression 106c extending downwardly on a side surface 56 of a pusher blade 108 in the form of a relief having the respective long depression 106c (only two of four long depressions shown in FIG. 10) extend all the way down to the top surface of a base 60.

FIG. 1 All the parts have been defined above. The rest of the detailed description of embodiment will now focus on how all the above mentioned parts work together in a structured way to cut an array of slice through food pieces 110, and long cut wedge pieces 112 from one end of a food product to the opposite longitudinal end.

And finally, this will define how the two above cut operations and parts work together in a three dimensional way to create cut cubed or diced food pieces 16. Creating slices 110 from a food product described next.

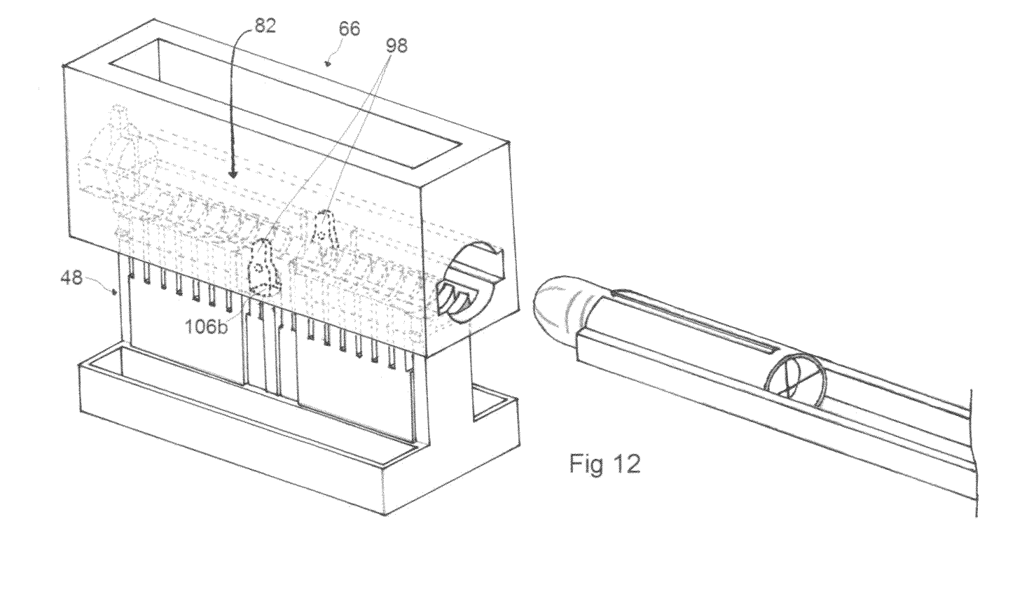

FIG. 12 A cutter housing 66 with it's gravity assisted lever lock 98 generally vertically oriented, is positioned by hand on top of a food ejectors 48 lock stop ledge 106b (only one of two lock stop ledges shown in FIG. 12) having the respective food ejector 48 and the respective cutter housing 66 form a lower momentary food containment chamber 82.

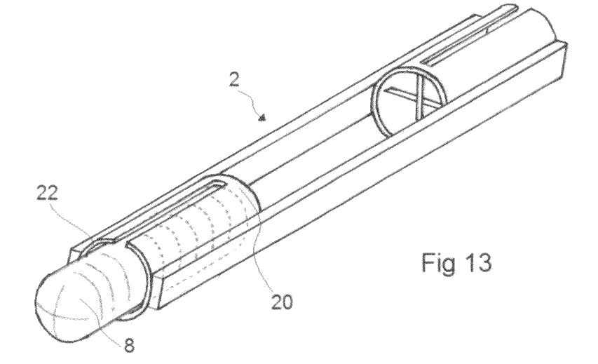

FIG. 13 A jumbo size sausage product 8 is inserted by hand into a tubular containment chambers 20 food product inlet 22 located at one end of a two handle beam apparatus 2.

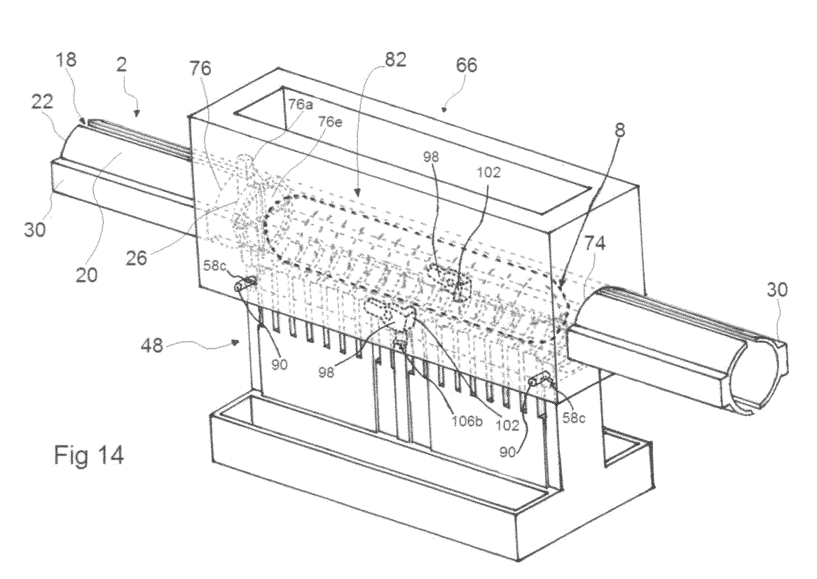

FIG. 14 In this example, a two handle beam apparatus 2 has three purposeful applications, in that it is intended for holding and locating a jumbo size sausage product 8, than rotating a lever lock 98 off a lock stop ledge 106b (only one of two lock stop ledges shown in FIG. 14).

A tubular containment chambers 20 food product inlet 22 containing a jumbo size sausage product 8 (shown in dark hidden lines in FIG. 14) is inserted by hand into a cutter housings 66 handle beam inlet 74.

A guide beam 30 on a tubular containment chamber 20 will intersect and rotate the upper portion of a lever lock 98 to a generally horizontal position, which would be the effort on a class one lever and than release a lower ledge 102 of the respective lever lock 98 off of a food ejectors 48 lock stop ledge 106b.

A cutter housing 66 is still resting on a food ejectors 48 locator ledge 58c (only two of four locator ledges shown in FIG. 14), with it's spring plunger 90 (only two of four spring plungers shown in FIG. 14).

A jumbo size sausage product 8 is stopped by a food barrier 76e as the tubular containment chambers 20 stop slot 18 (only one of two stop slots shown in FIG. 14) allow it to continue through a handle beam outlet 76 and come to a complete stop with the closed end of the respective stop slot 18 resting against a pillar 76a.

A food product outlet 26 on a tubular containment chamber 20 clears a lower momentary food containment chamber 82 formed by a cutter housing 66 resting on a food ejector 48, to create a resting place for a sausage food product 8.

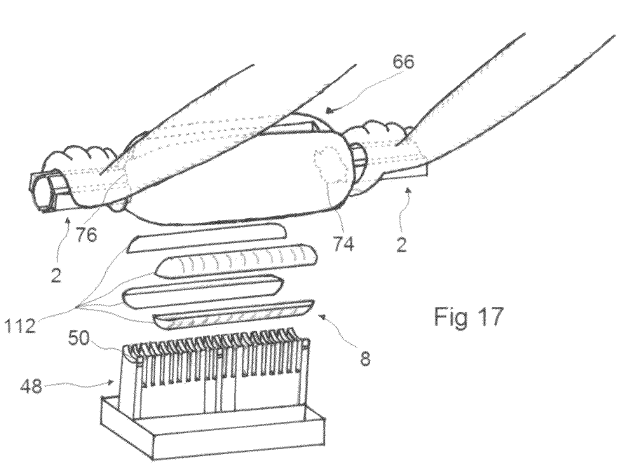

FIG. 17 At this point a person would manually push down on a two handle beam apparatus 2 that now sticks out of a handle beam inlet 74 and a handle beam outlet 76 located on each end of a cutter housing 66.

FIG. 5 An array of pusher blades 58, 106, 108, 109 located on a food ejector 48 FIG. 6 would force a jumbo size sausage product 8 through an array of cutting blades 72 located in a cutter housing 66 to a new resting position in a upper momentary food containment chamber 70.

FIG. 1 A jumbo size sausage product 8 is now in the form of an array of evenly sliced through pieces 110.

Creating long wedge cuts 112 from a food product described next.

FIG. 12 A cutter housing 66 with it's gravity assisted lever lock 98 generally vertically oriented, is positioned by hand on top of a food ejectors 48 lock stop ledge 106b (only one of two lock stop ledges shown in FIG. 12) having the respective food ejector 48 and the respective cutter housing 66 form a lower momentary food containment chamber 82.

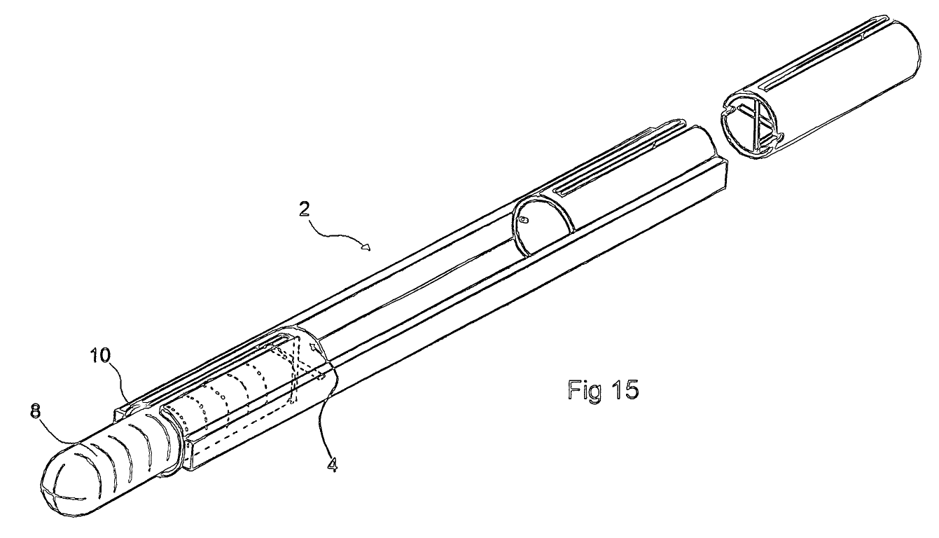

FIG. 15 A jumbo size sausage product 8 is inserted by hand into a tubular containment cutting chambers 4 food product inlet 10 located at one end of a two handle beam apparatus 2.

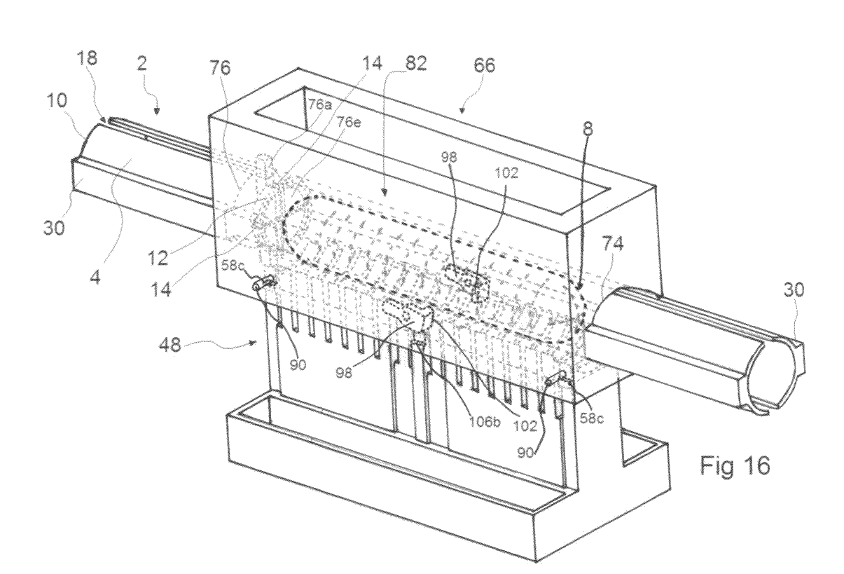

FIG. 16 In this example, a two handle beam apparatus 2 has four purposeful applications, in that it is intended for holding, locating, and cutting a jumbo size sausage product 8, than rotating a lever lock 98 off a lock stop ledge 106b (only one of two lock stop ledges shown in FIG. 16).

A tubular containment cutting chambers 4 food product inlet 10 containing a jumbo size sausage product 8 (shown in dark hidden lines in FIG. 16) is inserted by hand into a cutter housings 66 handle beam inlet 74.

A guide beam 30 on a tubular containment cutting chamber 4 will intersect and rotate the upper portion of a lever lock 98 to a generally horizontal position, which would be the effort on a class one lever and than release a lower ledge 102 of the respective lever lock 98 off of a food ejectors 48 lock stop ledge 106b (only one of two lock stop ledges shown in FIG. 16).

A cutter housing 66 is still resting on a food ejectors 48 locator ledge 58c (only one of two locator ledges shown in FIG. 16), with it's spring plunger 90 (only one of two spring plungers shown in FIG. 16).

A jumbo size sausage product 8 is stopped by a food barrier 76e as the tubular containment cutting chambers 4 stop slots 18 (only one of two stop slots shown in FIG. 16) allow it to continue through a handle beam outlet 76 while slicing the respective jumbo size sausage product 8 with it's knifes or wires 14 and comes to a complete stop with the closed end of the respective stop slots 18 resting against a pillar 76a.

A food product outlet 12 on a tubular containment cutting chamber 4 clears a lower momentary food containment chamber 82 formed by a cutter housing 66 resting on a food ejector 48, to create a resting place for a jumbo size sausage food product 8.

FIG. 17 At this point a person would manually lift on a two handle apparatus 2 that now sticks out a handle beam inlet 74 and a handle beam outlet 76 located on each end of a cutter housing 66.

Once a cutter housing is lifted off a food ejector 48, a jumbo size sausage product 8 is now in the form of four, but not limited too, long wedge cuts 112 down it's longitudinal length all the way through, which would normally be resting on the top surface 50 of the respective food ejector 48.

FIG. 1 Creating cubed or diced cuts 16 from a food product 8 described next. FIG. 12 A cutter housing 66 with it's gravity assisted lever lock 98 generally vertically oriented, is positioned by hand on top of a food ejectors 48 lock stop ledge 106b (only one of two lock stop ledges shown in FIG. 12).

having the respective food ejector 48 and the respective cutter housing 66 form a lower momentary food containment chamber 82.

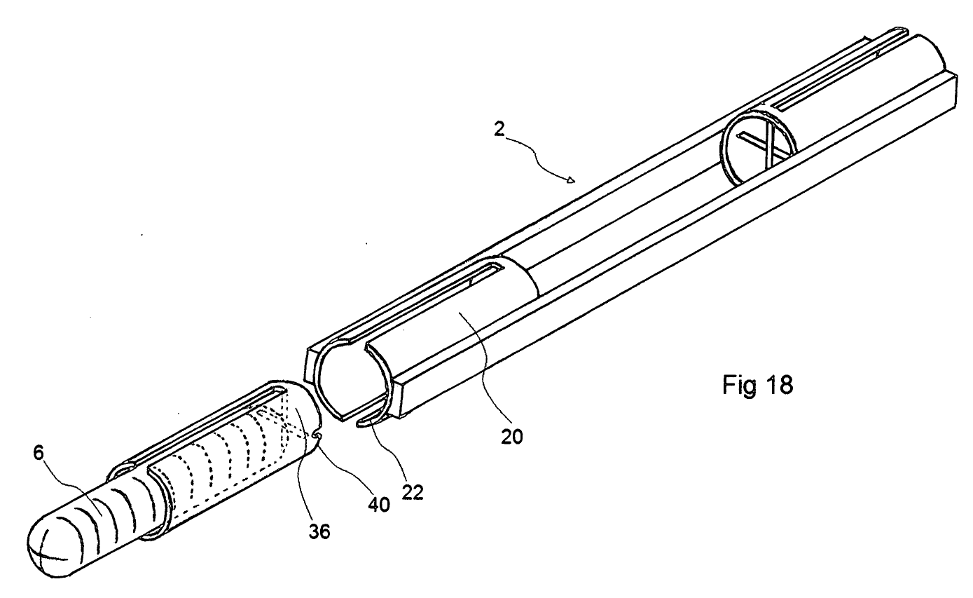

FIG. 18 A tubular sleeve containment cutting chambers 36 food product outlet end 40 is telescopically inserted by hand into a tubular containment chambers 20 food product inlet 22 located at one end of a two handle beam apparatus 2 until FIG. 3 it's sleeve locator slot 46 comes to a rest and locates with a sleeve locator pin 24.

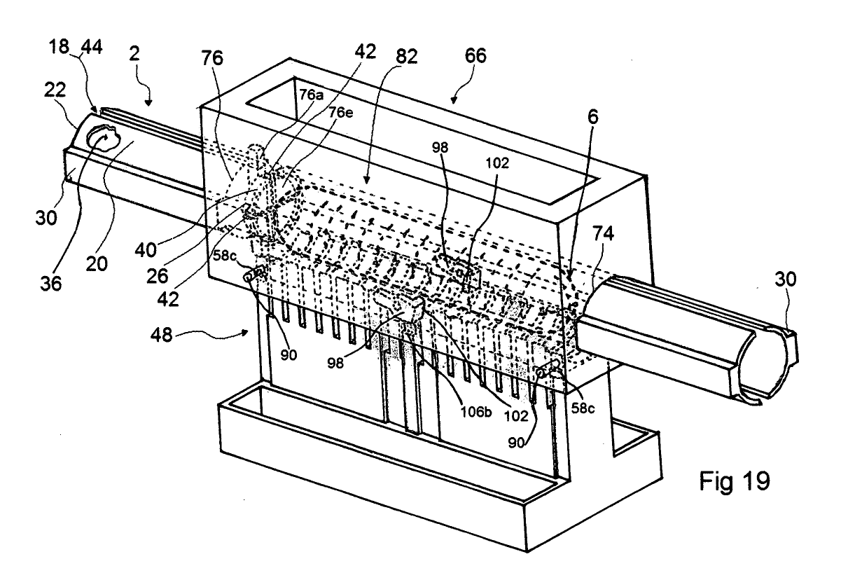

FIG. 19 A standard size sausage product 6 (shown in dark hidden lines in FIG. 19) is inserted by hand into a tubular sleeve containment cutting chamber 36 now located at one end of a two handle beam apparatus 2.

In this example, a two handle beam apparatus 2 has four purposeful applications, in that it is intended for holding, locating, and cutting a standard size sausage product 6, than rotating a lever lock 98 off a lock stop ledge 106b (only one of two lock stop ledges shown in FIG. 19).

FIG. 4 A tubular sleeve containment cutting chambers 36 having a food outlet end 40, telescopically forced by hand into a tubular containment chambers 20 food inlet end 22.

A standard size sausage product 6 is inserted by hand into a tubular sleeve containment cutting chambers 36 food product inlet 38 now located at one end of a two handle beam apparatus 2.

FIG. 19 A tubular containment chambers 20 food product inlet 22 now containing a tubular sleeve containment cutting chamber 36 (shown through a drawn cut out viewing hole on the respective tubular containment chamber 20).

A standard size sausage product 6 is inserted by hand into a cutter housings 66 handle beam inlet 74.

A guide beam 30 on a tubular containment chamber 20 will intersect and rotate the upper portion of a lever lock 98 to a generally horizontal position, which would be the effort on a class one lever and than release a lower ledge 102 of the respective lever lock 98 off of a food ejectors 48 lock stop ledge 106b.

A cutter housing 66 is still resting on a food ejectors 48 locator ledge 58c (only one of two locator ledges shown in FIG. 19), with it's spring plunger 90 (only one of two spring plungers shown in FIG. 19).

A standard size sausage product 6 is stopped by a food barrier 76e as tubular containment chambers 20 stop slots 18 (only one of two stop slots shown in FIG. 19) and the tubular sleeve containment cutting chambers 36 stop slots 44 (only one of two stop slots shown in FIG. 19) allow it to continue through a handle beam outlet 76 while slicing the respective standard size sausage product 6 with it's knifes or wires 42 and comes to a complete stop with the closed end of the respective stop slots 18, 44 resting against a pillar 76a.

Both food product outlets 26, 40 on a tubular containment chamber 20 and tubular sleeve containment cutting chamber 36 clear a lower momentary food containment chamber 82 formed by a cutter housing 66 resting on a food ejector 48, to create a resting place for a food product.

A standard size sausage product 6 is now in the form of four, but not limited too, FIG. 17 long wedge cuts 112 down it's longitudinal length all the way through, which would now rest on the top surface 50 of the respective food ejector 48 (for illustration purposes, the long wedge cuts are shown floating above the respective food ejector 48).

FIG. 19 At this point a person would manually push down on a two handle beam apparatus 2 that now sticks out of a handle beam inlet 74 and a handle beam outlet 76 located on each end of a cutter housing 66.

FIG. 5 An array of pusher blades 58, 106, 108, 109 located on a food ejector 48 FIG. 17 would force the long wedge cuts 112 through FIG. 6 an array of cutting blades 72 located in a cutter housing 66 to a new resting position in a upper momentary food containment chambers 70.

FIG. 1 A standard size sausage product is now in the form of an array of evenly sliced and diced pieces 16, which would normally be resting in an upper momentary food containment chamber 70. (For illustration purposes, the respective sliced and diced pieces are shown floating above the respective cutter housing 66).

FIG. 10 A lever lock 98 could be fitted with a number of different spring returns for a resilient return to a generally vertical position.

A resilient spring return for a lever lock 98 to a generally vertical position would be obvious to one in the art and easily designed in numerous ways, so no illustration of a spring return is shown in the drawings.

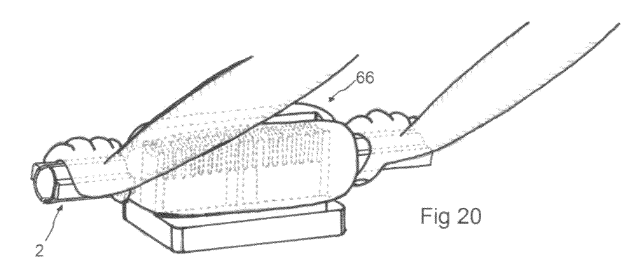

FIG. 20 A cutter housing 66 and two handle beam apparatus 2 could be fitted with blades, wires, or any other known cutting device for slicing through a hot dog. Although particular embodiments of the present invention have been described in the foregoing detailed description, it will be understood that the invention is capable of numerous sizes, rearrangements, modifications, and substitutions of parts without departing from the scope of the invention as set forth in the claims below.

What is claimed is:

1. A sausage food product slicer, and dicer, manual cutting device, comprising:
a two handle beam apparatus for slicing a sausage food product includes at one end a tubular containment cutting chamber having a longitudinal length generally similar to a standard size sausage product and an inside diameter with a generally larger circumference than a jumbo size sausage products outside circumference:
a said tubular containment cutting chamber having a food product inlet at one end and a food product outlet which is provided with a knife or wire for cutting:
at this point the ultimate focus is on a diced sausage food product, so it would require, but not limited too, more than one said knife or wire used for cutting a jumbo size sausage product, and the respective knifes or wires would be spaced at a 90 degree angle from each other around the inside circumference of a said tubular containment cutting chambers said food product outlet end:
an elongated stop slot shown cut through from the outer surface to the inner surface of a said tubular containment cutting chamber having the same longitudinal axis:
a said stop slot having an opening from a said food product inlet end, and extending the respective opening to a distance just short of a said food product outlet end without an opening:
a said two handle beam apparatus for slicing a sausage food product includes at the opposite longitudinal end a tubular containment chamber having a longitudinal length generally similar to a said standard size sausage product, and an inside diameter with a generally larger circumference than a said jumbo size sausage products outside circumference:
a tubular containment chamber is provided with a food product inlet at one end and a food product outlet at the other end, with two short sleeve locator pins:
an elongated stop slot shown cut through from the outer surface to the inner surface of a said tubular containment chamber having the same longitudinal axis:
a said stop slot having an opening from a said food product inlet end and extending the respective opening to a distance just short of a said food product outlet end without an opening:
a horizontal guide beam having the same longitudinal axis as a said tubular containment cutting chamber and a said tubular containment chamber:
a said tubular containment cutting chamber and a said tubular containment chamber have a fixed mount on the outer surface with a said guide beam:
a middle portion of a said guide beam spanning an opening between the said food product outlet end of a said tubular containment cutting chamber and a said food product outlet end of a said tubular containment chamber generally longer than the distance of a said standard size sausage product, forming a said two handle beam apparatus all together:
a tubular sleeve containment cutting chamber is a separate piece, but has the same form and function of a said tubular containment cutting chamber:
a plurality of said pusher blades extending generally up a said food ejector:
a said food ejector is provided with a top surface longitudinally configured generally longer and generally wider than a said jumbo size sausage product having the respective top surface recessed, with the sides higher than the center creating a lateral centering means for the respective jumbo size sausage product:
a said food ejector having an array of transversely oriented clearance slots open from a said top surface and opened on both side surfaces extending downwardly to a predetermined clearance depth forming said pusher blades:
an upper depression located on a said pusher blades said side surface at each end of a said food ejector, in the form of an upper relief:
a lower depression located on a said pusher blades side surface at each end of a said food ejector, in the form of a lower relief:
a said side surface that stands between a said upper depression and a said lower depression located on a said pusher blade, takes the form of a momentary locator ledge:
a top surface of a said base is fixed mounted to the bottom of a said food ejector having generally the same longitudinal length, and extending out laterally for enhanced stability in the form of a reservoir on each side:
a cutter housing is provided with a food product outlet on the top surface longitudinally configured to be generally longer, and generally wider than one said jumbo size sausage product:
a said cutter housing is provided with an upper momentary food containment chamber from a top surface to be generally deeper than the thickness of a said jumbo size sausage product:
a said upper momentary food containment chamber is provided with an array of transversely oriented cutting blades configured longitudinally:
a said cutter blades top surface starts from the bottom of the respective upper momentary food containment chamber, and extends downwardly to a sharp edge similar to a knife taking the form of top circumference on a handle beam inlet, and handle beam outlet:
a said cutter blades lateral ends have a fixed mount to a said upper momentary food containment chambers side surfaces:
a bottom sharp edge of a said cutter blade having the sides lower than the center of the respective cutter blade, longitudinally configured into a lateral centering and cutting means for a jumbo size sausage product:
a said cutter housing is provided with a said handle beam inlet at one end, and a said handle beam outlet at the opposite longitudinal end having the middle portion forming a lower momentary food containment chamber opened therethrough to the bottom surface of the respective cutter housings food ejector inlet:
a said handle beam inlet and a said handle beam outlet having a generally slightly larger inside circumference than a said tubular containment cutting chamber and a said tubular containment chambers out side circumference:
a said handle beam inlet and a said handle beam outlet are provided with openings on there inside circumference called a guide beam slot oriented longitudinally all the way through a said cutter housing:
a said guide beam slot having a generally slightly larger inside dimension than a said guide beams outside dimension:
a said handle beam outlet located on one end of a said cutter housing is provided with a center mounted vertically oriented pillar having a said top and bottom fixed mount to the inside circumference of the respective handle beam outlet:
a said pillar having a generally smaller lateral thickness than a said stop slots lateral width opening:
a said pillar having a fixed mount on a backside surface of a food barrier:
a clearance slot having a generally larger opening and depth than a said knife or wire that's provided inside a said tubular containment cutting chamber, and a said tubular sleeve containment cutting chamber:
at this point the ultimate focus is on a said diced sausage product, so it would require, but not limited too, more than one said clearance slot that would be spaced at a 90 degree angle from each other around the outside circumference of a said food barrier:
a said cutter housing is provided with a said food ejector inlet on it's said bottom surface longitudinally configured to be generally longer, and generally wider than one said jumbo size sausage product:
a cutter housing is provided with a said lower momentary food containment chamber having an opening on a said bottom surface, which is termed a said food ejector inlet, extending upwards to be a generally deeper pocket than two jumbo size sausage products:
a said food ejector inlet and a said food product outlet located on a said cutter housing, are provided with a slightly larger inside length and width dimension than a said food ejector and all of said pusher blades outside length and width dimension for an easy slip fit when the respective food ejector and the respective cutter housing are telescopically put together:
a said cutter housing provided with a spring plunger in the form of a momentary locator point:
a said spring plunger having a transversely oriented fixed mount on an inside surface with all four momentary locator points, just inside a said food ejector inlet, to line up with an upper depression and a lower depression located on a said pusher blades said side surface:
a said spring plunger generally extending into a lower momentary food containment chamber from a said food ejector inlets said inside surface to rest on a momentary locator ledge, located on a said side surface of a said pusher blade:
a said cutter housing is provide with a lever lock pocket cut through from a bottom surface to form a lever slot opening to the lower portion of a said guide beam slot:
a said cutter housing is provide with a said lever lock pocket having openings on a said bottom surface generally part way up on a said inside surface, and having no openings to an outside surface:
a said cutter housing is provided with a lever lock having the form of a class one lever:
a said lever lock is provided with a pivot hole in the center acting as a fulcrum point on a class one lever:
a said lever locks lower ledge portion is in the form of a boot, with the toe of the boot pointing inwardly generally beyond a said inside surface and protruding into a said lower momentary food containment chamber:
a said lower ledge of a said lever lock is used as a safety stop for a cutter housing, when positioned on top of a center pusher blades lock stop ledge located on a food ejector:
a lower said lever lock pocket and upper said lever slot surface length openings are generally longer than a said lever locks total longitudinal length, allowing the respective lever lock to rotate from a generally vertical position to a generally 90 degree horizontal position:
a lateral width of a upper said lever slot having a slightly larger slip fit for a lever locks 98 upper lateral width:
a said lever lock is provided with a pivot mount, but in a generally vertical position, inside a said lever lock pocket, and having a longitudinal center location inside a said lower momentary food containment chamber:
a short upper depression extending generally a short distance downwardly from a top surface on a center pusher blade, having the top edge of a remaining said side surface creating a lock stop ledge:
a long depression extending downwardly on a said side surface of a pusher blade in the form of a relief having the respective long depression extend all the way down to the top surface of a said base:

2. A sausage food product slicer and dicer, manual cutting device of claim 1, wherein said a tubular containment chamber is provided with a food product inlet at one end and a food product outlet at the other end, with two short sleeve locator pins located across from each other generally near the respective food product outlet end:
a said sleeve locator pin having a fixed mount in a transverse position from a said tubular containment chambers inside surface pointing inwardly:

3. A sausage food product slicer and dicer, manual cutting device of claim 1, wherein said a tubular sleeve containment cutting chamber is a generally smaller version of a said tubular containment cutting chamber, and is a separate piece, but both have the same form and function:
a tubular sleeve containment cutting chamber having a telescopic sleeve mount to a said tubular containment chamber:
a said tubular sleeve containment cutting chamber having a longitudinal length generally similar to a said standard size sausage product, and an inside diameter with a generally larger circumference than the respective standard size sausage products outside circumference:
a said tubular sleeve containment cutting chamber having an outside diameter generally smaller than a said tubular containment chambers inside diameter:
a said tubular sleeve containment cutting chamber having a food product inlet at one end and a food product outlet which is provided with a knife or wire for cutting:
at this point the ultimate focus is on a said diced sausage food product, so it would require, but not limited too, more than one said knife or wire used for cutting a said standard size sausage product, and the respective knifes or wires would be spaced at a 90 degree angle from each other around the inside circumference of a said tubular sleeve containment cutting chambers said food product outlet end:
an elongated stop slot shown cut through from the outer surface to the inner surface of a said tubular sleeve containment cutting chamber having the same longitudinal axis:
a said stop slot having an opening from a said food product inlet end and extending the respective opening to a distance just short of a said food product outlet end without an opening:
a said tubular sleeve containment cutting chambers said food outlet end is telescopically forced by hand into a said tubular containment chambers said food inlet end:
a said tubular sleeve containment cutting chamber having a generally short sleeve locator slot with an opening at its said food product outlet end:
a said sleeve locator slot is used for locating, aligning, and stopping a telescopically mounted said tubular sleeve containment cutting chamber with a generally short said sleeve locator pin inside a said tubular containment chamber:
